(19) United States
(12) Patent Application Publication
(10) Pub. No.: US 2025/0124342 A1
(43) Pub. Date: Apr. 17, 2025

(54) FEDERATED LEARNING METHOD AND SYSTEM USING SHARED LEARNING DATA

(71) Applicant: Foundation for Research and Business, Seoul National University of Science and Technology, Seoul (KR)

(72) Inventors: Seung Eun LEE, Seoul (KR); Jeong Eun KIM, Gyeonggi-do (KR); Young Woo JEONG, Seoul (KR)

(73) Assignee: Foundation for Research and Business, Seoul National University of Science and Technology, Seoul (KR)

(21) Appl. No.: 18/529,584

(22) Filed: Dec. 5, 2023

(30) Foreign Application Priority Data
Oct. 16, 2023 (KR) 10-2023-0138040

(51) Int. Cl. G06N 20/00

(52) U.S. Cl. CPC G06N 20/00

(57) ABSTRACT

Provided is a federated learning method and system using shared learning data. The federated learning method includes determining shared learning data to be provided to federated learning devices, learning each of artificial intelligence (AI) models by each of the federated learning devices using the shared learning data and unique learning data of each of the federated learning devices, and determining a final model by a final model determination server based on a learning result of the AI models.

### CROSS-REFERENCE TO RELATED APPLICATIONS

This application claims the benefit of Korean Patent Application No. 10-2023-0138040 filed on Oct. 16, 2023, in the Korean Intellectual Property Office, the entire disclosure of which is incorporated herein by reference for all purposes.

### BACKGROUND

### 1. Field of the Invention

One or more embodiments relate to a federated learning method and system, and particularly, to a federated learning method and system using shared learning data.

### 2. Description of the Related Art

Federated learning is a learning method that trains a model by distributing pieces of learning data between artificial intelligence (AI) devices or devices. Federated learning may improve the quality and performance of a model while alleviating concerns about privacy and data security by updating of the model while preserving learning data on each of different local devices.

The federated learning method according to the related art distributes pieces of learning data to a plurality of local devices, and each local device updates a model through the distributed pieces of learning data. However, when a problem occurs in one of the local devices, there is no device that may replace the local device in which the problem occurred or data that may replace the result learned from the local device, and thus, technical loss may occur due to this problem.

In addition, non-cooperative devices that have errors or failures may transmit incorrect data or perform malicious operations, which may reduce the accuracy and reliability of a model. Therefore, there is a need for a method of preventing errors in federated learning even when some of federated learning devices malfunction.

### SUMMARY

Embodiments provide a method and system for securing the fault tolerance of federated learning by sharing a portion of learning data by federated learning devices in a federated learning system even when some of the federated learning devices malfunction.

According to an aspect, there is provided a federated learning method including determining shared learning data to be provided to federated learning devices, learning each of artificial intelligence (AI) models by each of the federated learning devices using the shared learning data and unique learning data of each of the federated learning devices, and determining a final model by a final model determination server based on a learning result of the AI models.

The determining of the shared learning data may include generating the shared learning data by collecting pieces of data that are set as essential data in the unique learning data of each of the federated learning devices.

The determining of the shared learning data may include generating the shared learning data by collecting pieces of data that do not overlap with the unique learning data of each of the federated learning devices.

According to another aspect, there is provided a federated learning method including receiving pieces of unique learning data from each of federated learning devices, determining shared learning data to be provided to the federated learning devices based on the pieces of unique learning data, learning each of AI models by each of the federated learning devices using the shared learning data and the pieces of unique learning data, and determining a final model by a final model determination server based on a learning result of the AI models.

The determining of the shared learning data may include generating shared learning data to be provided to different federated learning devices using data extracted from the pieces of unique learning data of each of the federated learning devices.

Additional aspects of embodiments will be set forth in part in the description which follows and, in part, will be apparent from the description, or may be learned by practice of the disclosure.

According to embodiments, federated learning devices in a federated learning system may secure the fault tolerance of federated learning by sharing a portion of learning data even when some of the federated learning devices malfunction.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a federated learning system according to an embodiment;

FIG. 2 is a diagram illustrating an example of an operation of a federated learning system according to an embodiment;

FIG. 3 is a diagram illustrating an example of an operation of a federated learning system according to an embodiment;

FIG. 4 is a flowchart illustrating a federated learning method according to an embodiment; and

FIG. 5 is a flowchart illustrating a federated learning method according to an embodiment.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Hereinafter, embodiments will be described in detail with reference to the accompanying drawings.

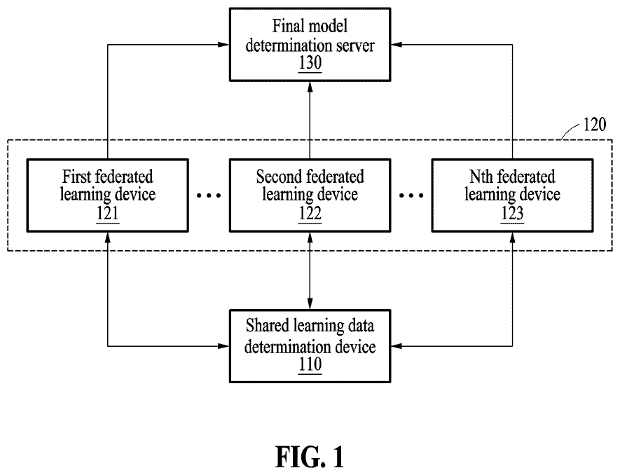

FIG. 1 is a diagram illustrating a federated learning system according to an embodiment.

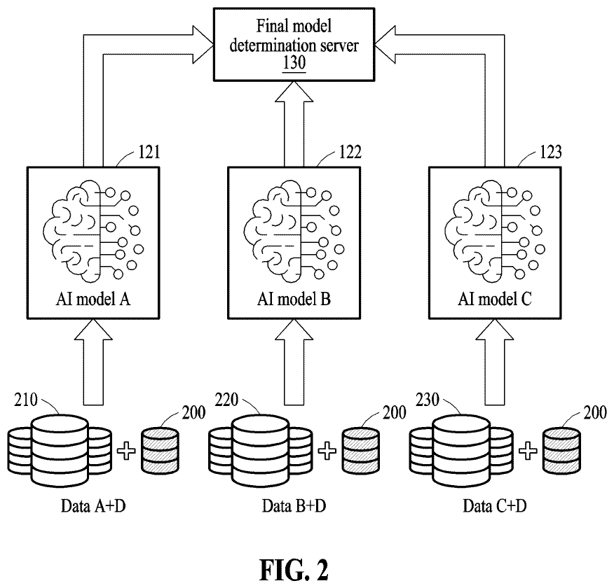

A federated learning system according to an embodiment of the present disclosure may include a shared learning data determination device 110, federated learning devices 120, and a final model determination server 130, as shown in FIG. 1. Here, the shared learning data determination device 110 and the federated learning devices 120 may be terminals or devices including different processors, as shown in FIG. 2. In addition, the shared learning data determination device 110, the federated learning devices 120, and the final model determination server 130 may be one server or different processors included in a terminal and may be each module included in a program performed by one processor.

The shared learning data determination device 110 may determine shared learning data to be provided to the federated learning devices 120. Here, the shared learning data determination device 110 may collect pieces of data that are set as essential data in unique learning data of each of the federated learning devices 120 and generate shared learning data. In addition, the shared learning data determination device 110 may collect pieces of data that do not overlap with the unique learning data of each of the federated learning devices 120 and generate shared learning data.

Additionally, the shared learning data determination device 110 may receive pieces of unique learning data of each of the federated learning devices 120. Here, the shared learning data determination device 110 may determine shared learning data to be provided to the federated learning devices 120 based on the received pieces of unique learning data.

Specifically, the shared learning data determination device 110 may generate shared learning data to be provided to different federated learning devices using data extracted from the unique learning data of each of the federated learning devices 120. For example, when N is 3, the shared learning data determination device 110 may generate shared learning data to be provided to a second federated learning device 122 using data extracted from unique learning data of a first federated learning device 121. In addition, the shared learning data determination device 110 may generate shared learning data to be provided to an Nth federated learning device 123 using data extracted from unique learning data of the second federated learning device 122. Additionally, the shared learning data determination device 110 may generate shared learning data to be provided to the first federated learning device 121 using data extracted from unique learning data of the Nth federated learning device 123.

As shown in FIG. 1, the federated learning devices 120 may include the first federated learning device 121, the second federated learning device 122 to the Nth federated learning device 123. Here, N may be the number of federated learning devices 120 included in the federated learning system. For example, when the federated learning system includes five federated learning devices 120, N may be 5 and the federated learning system may include the first federated learning device 121 to a fifth federated learning device.

Each of the first federated learning device 121, the second federated learning device 122 to the Nth federated learning device 123 may learn each of artificial intelligence (AI) models using the share learning data and the unique learning data of each of the first federated learning device 121, the second federated learning device 122 to the Nth federated learning device 123.

The final model determination server 130 may determine the final model based on a learning result of the AI models of the federated learning devices 120.

The federated learning system according to an embodiment of the present disclosure may secure the fault tolerance of federated learning by sharing a portion of learning data by the federated learning devices 120 even when some of the federated learning devices 120 malfunction.

FIG. 2 is a diagram illustrating an example of an operation of a federated learning system according to an embodiment.

An embodiment of the present disclosure shows that the federated learning devices 120 learn the same shared learning data with the unique learning data of each of the federated learning devices 120. For example, FIG. 2 is an example of an operation of a federated learning system where Nis 3.

In FIG. 2, data A 210 may be unique learning data of the first federated learning device 121, data B 220 may be unique learning data of the second federated learning device 122, and data C 230 may be unique learning data of the Nth federated learning device 123. Additionally, data D 200 may be shared learning data determined by the shared learning data determination device 110.

Here, the shared learning data determination device 110 may identify pieces of data that are set as essential data in each of the data A 210, the data B 220, and the data C 230. Next, the shared learning data determination device 110 may collect the identified pieces of data. Then, the shared learning data determination device 110 may generate and transmit the data D 200 including the collected pieces of data to the first federated learning device 121, the second federated learning device 122 to the Nth federated learning device 123.

In addition, the shared learning data determination device 110 may collect pieces of data that do not overlap with the data A 210, the data B 220, and the data C 230 from a separate storage medium, the Internet, or a database. Then, the shared learning data determination device 110 may generate and transmit the data D 200 including the collected pieces of data to the first federated learning device 121, the second federated learning device 122 to the Nth federated learning device 123.

Here, the first federated learning device 121 may learn an AI model A using the data A 210 and the data D 200, as shown in FIG. 2. Additionally, the second federated learning device 122 may learn an AI model B using the data B 220 and the data D 200. In addition, the Nth federated learning device 123 may learn an AI model C using the data C 230 and the data D 200. In addition, the final model determination server 130 may determine the final model based on a learning result of the AI models A, B, and C of the first federated learning device 121, the second federated learning device 122 to the Nth federated learning device 123. Here, the AI models A, B, and C may be learned to have characteristics and patterns for the data A 210, the data B 220, and the data C 230, respectively, and may form a complementary relationship with each other by sharing the data D 200. For example, when the first federated learning device 121 malfunctions, the final model determination server 130 may estimate the learning result of the first federated learning device 121 by referring to the learning result of the data D 200 from the second federated learning device 122 to the Nth federated learning device 123. In addition, the final model determination server 130 may normally determine the final model by determining the final model based on the estimated learning result and the learning result of the AI models B and C of the second federated learning device 122 to the Nth federated learning device 123 even when the first federated learning device 121 malfunctions.

For example, when the data D 200 includes pieces of data that are set as essential data in each of the data A 210, the data B 220, and the data C 230, the final model determination server 130 may identify and extract data that is set as essential data in the data A 210 from the data D 200 and may estimate the learning result of the first federated learning device 121 by referring to the learning result of the second federated learning device 122 to the Nth federated learning device 123 of the extracted data.

That is, since the AI models A, B, and C use a portion of the same data and learn different characteristics, the performance and the reliability of the AI models A, B, and C may be improved and the fault tolerance may be secured.

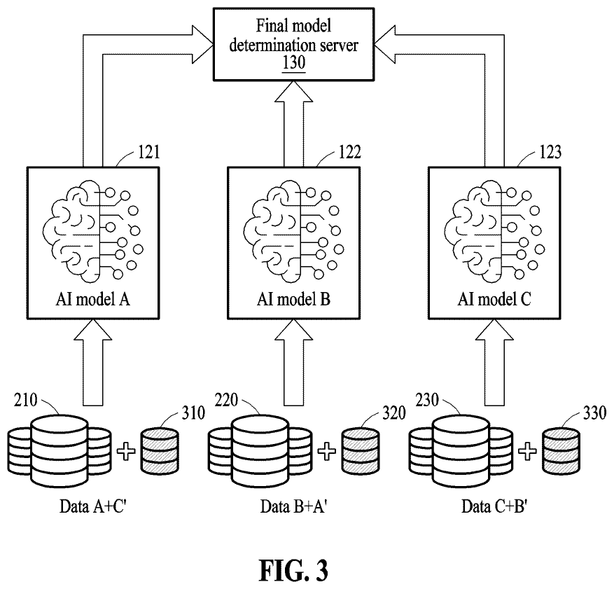

FIG. 3 is a diagram illustrating an example of an operation of a federated learning system according to an embodiment.

An embodiment of the present disclosure shows that the federated learning devices 120 learn unique learning data of different federated learning devices with their own unique learning data. For example, FIG. 3 is an example of an operation of the federated learning system where Nis 3.

In FIG. 3, the data A 210 may be unique learning data of the first federated learning device 121, the data B 220 may be unique learning data of the second federated learning device 122, and the data C 230 may be unique learning data of the Nth federated learning device 123. In addition, data C′ 310 may be data extracted from the unique learning data of the Nth federated learning device 123, data A′ 320 may be data extracted from the unique learning data of the first federated learning device 121, and data B′ 330 may be data extracted from the unique learning data of the second federated learning device 122.

Here, the first federated learning device 121 may learn the AI model A using the data A 210 and the data C′ 310, as shown in FIG. 3. Additionally, the second federated learning device 122 may learn the AI model B using the data B 220 and the data A′ 320. In addition, the Nth federated learning device 123 may learn the AI model C using the data C 230 and the data B′ 330. In addition, the final model determination server 130 may determine the final model based on the learning result of the AI models A, B, and C of the first federated learning device 121, the second federated learning device 122 to the Nth federated learning device 123.

Here, the AI model A may be learned to have a characteristic and pattern for a portion of the data A 210 and the data C 230 using the data C′ 310 extracted from the data A 210 and the data C 230. In addition, the AI model B may be learned to have a characteristic and pattern for a portion of the data B 220 and the data A 210 using the data A′ 320 extracted from the data B 220 and the data A 210. Additionally, the AI model C may be learned to have a characteristic and pattern for a portion of the data C 230 and the data B 220 using the data B′ 330 extracted from the data C 230 and the data B 220.

Accordingly, the federated learning system according to an embodiment of the present disclosure may secure the fault tolerance of federated learning even when some of the federated learning devices 120 malfunction.

For example, when the first federated learning device 121 malfunctions, the final model determination server 130 may estimate the learning result of the first federated learning device 121 by referring to the learning result of the data A′ 320 from the second federated learning device 122. In addition, the final model determination server 130 may normally determine the final model by determining the final model based on the estimated learning result and the learning result of the AI models B and C of the second federated learning device 122 to the Nth federated learning device 123 even when the first federated learning device 121 malfunctions.

That is, since the AI models A, B, and C use a portion of the same data and learn different characteristics, the performance and the reliability of the AI models A, B, and C may be improved and the fault tolerance may be secured.

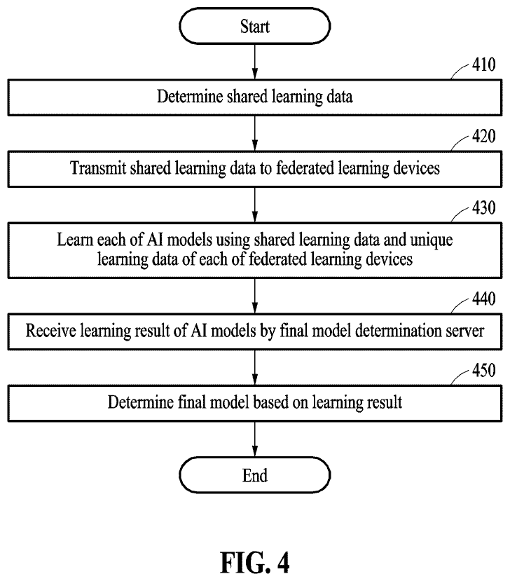

FIG. 4 is a flowchart illustrating a federated learning method according to an embodiment.

In operation 410, the shared learning data determination device 110 may determine shared learning data to be provided to the first federated learning device 121, the second federated learning device 122 to the Nth federated learning device 123. Here, the shared learning data determination device 110 may collet pieces of data that are set as essential data in the unique learning data of each of the first federated learning device 121, the second federated learning device 122 to the Nth federated learning device 123 and may generate shared learning data. In addition, the shared learning data determination device 110 may collet pieces of data that do not overlap with the unique learning data of each of the first federated learning device 121, the second federated learning device 122 to the Nth federated learning device 123 and may generate shared learning data.

In operation 420, the shared learning data determination device 110 may transmit the shared learning data determined in operation 410 to each of the first federated learning device 121, the second federated learning device 122 to the Nth federated learning device 123.

In operation 430, each of the first federated learning device 121, the second federated learning device 122 to the Nth federated learning device 123 may learn each of the AI models A, B, and C using the shared learning data received in operation 420 and the unique learning data of each of the first federated learning device 121, the second federated learning device 122 to the Nth federated learning device 123.

In operation 440, each of the first federated learning device 121, the second federated learning device 122 to the Nth federated learning device 123 may transmit the learning result from operation 430 to the final model determination server 130.

In operation 450, the final model determination server 130 may determine the final model based on the learning result of the AI models A, B, and C of the federated learning devices 120 received in operation 440.

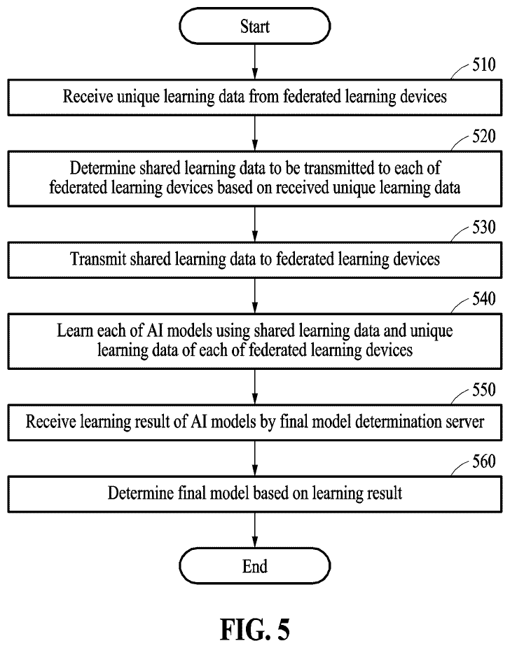

FIG. 5 is a flowchart illustrating a federated learning method according to an embodiment.

In operation 510, the shared learning data determination device 110 may receive the unique learning data of each of the first federated learning device 121, the second federated learning device 122 to the Nth federated learning device 123 from the first federated learning device 121, the second federated learning device 122 to the Nth federated learning device 123.

In operation 520, the shared learning data determination device 110 may determine shared learning data to be provided to the federated learning devices 120 based on the unique learning data received in operation 510. Specifically, the shared learning data determination device 110 may generate shared learning data to be provided to different federated learning devices using data extracted from the unique learning data of each of the federated learning devices 120. For example, when N is 3, the shared learning data determination device 110 may generate shared learning data to be provided to the second federated learning device 122 using data extracted from the unique learning data of the first federated learning device 121. Additionally, the shared learning data determination device 110 may generate shared learning data to be provided to the Nth federated learning device 123 using data extracted from the unique learning data of the second federated learning device 122. In addition, the shared learning data determination device 110 may generate shared learning data to be provided to the first federated learning device 121 using data extracted from the unique learning data of the Nth federated learning device 123.

In operation 530, the shared learning data determination device 110 may transmit the shared learning data determined in operation 520 to each of the first federated learning device 121, the second federated learning device 122 to the Nth federated learning device 123.

In operation 540, each of the first federated learning device 121, the second federated learning device 122 to the Nth federated learning device 123 may learn each of the AI models A, B, and C using the shared learning data received in operation 530 and the unique learning data of each of the first federated learning device 121, the second federated learning device 122 to the Nth federated learning device 123.

In operation 550, each of the first federated learning device 121, the second federated learning device 122 to the Nth federated learning device 123 may transmit the learning result learned from operation 540 to the final model determination server 130.

In operation 560, the final model determination server 130 may determine the final model based on the learning result of the AI models A, B, and C of the federated learning devices 120 received in operation 550.

The present disclosure may secure the fault tolerance of federated learning by sharing a portion of learning data by the federated learning devices 120 in the federated learning system even when some of the federated learning devices 120 malfunction.

Furthermore, the federated learning device or the federated learning method based on speech data according to the present disclosure is provided as a computer-executable program and may be implemented as various recording media such as magnetic storage media, optical reading media, digital storage media, etc.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned embodiments is required for all the embodiments, and it should be understood that the aforementioned program components and apparatuses may be integrated into a single software product or packaged into multiple software products.

The embodiments disclosed in the present specification and the drawings are intended merely to present specific examples in order to aid in understanding of the disclosure, but are not intended to limit the scope of the disclosure. It will be apparent to those skilled in the art that various modifications based on the technical spirit of the disclosure, as well as the disclosed embodiments, can be made.

What is claimed is:

1. A federated learning method comprising:
determining shared learning data to be provided to federated learning devices;
learning each of artificial intelligence (AI) models by each of the federated learning devices using the shared learning data and unique learning data of each of the federated learning devices; and
determining a final model by a final model determination server based on a learning result of the AI models.

2. The federated learning method of claim 1, wherein the determining of the shared learning data comprises generating the shared learning data by collecting pieces of data that are set as essential data in the unique learning data of each of the federated learning devices.

3. The federated learning method of claim 1, wherein the determining of the shared learning data comprises generating the shared learning data by collecting pieces of data that do not overlap with the unique learning data of each of the federated learning devices.

4. A federated learning method comprising:
receiving pieces of unique learning data from each of federated learning devices;
determining shared learning data to be provided to the federated learning devices based on the pieces of unique learning data;
learning each of artificial intelligence (AI) models by each of the federated learning devices using the shared learning data and the pieces of unique learning data; and
determining a final model by a final model determination server based on a learning result of the AI models.

5. The federated learning method of claim 4, wherein the determining of the shared learning data comprises generating shared learning data to be provided to different federated learning devices using data extracted from the pieces of unique learning data of each of the federated learning devices.
